(19) United States
(12) Patent Application Publication
(10) Pub. No.: US 2012/0003921 A1
(43) Pub. Date: Jan. 5, 2012

(54) SOLUTION FOR THE SCALABILITY OF BROADCAST FORWARDING IN VEHICULAR NETWORKS BY MAP-REFERENCED INFORMATION ON NODE POSITION

(75) Inventors: Riccardo Maria SCOPIGNO, Vignole Borbera (AL) (IT); Hector Agustin COZZETTI, Biella (BI) (IT)

(73) Assignee: STMICROELECTRONICS S.R.L., Agrate Brianza (IT)

(21) Appl. No.: 13/153,933

(22) Filed: Jun. 6, 2011

(30) Foreign Application Priority Data
Jun. 6, 2010 (IT) VI2010A000165

(51) Int. Cl. H04W 4/00; H04H 20/71

(52) U.S. Cl. 455/3.01

(57) ABSTRACT

An embodiment of an apparatus includes a receiver operable to receive a message, and a processor operable to determine whether to broadcast the message. For example, the receiver and processor may be disposed on a first vehicle, and the receiver may receive the message from a second vehicle, where the message includes information related to a traffic-related event. The processor may determine whether to broadcast the message to other vehicles based on, e.g., the location of the first vehicle, the location of the second vehicle, the location of the event, or whether the processor has received the message more than once. The processor may determine not to broadcast the message if, based on these or other factors, it determines that the benefit of broadcasting the message is outweighed by the potential of the message, if broadcast, to “clog” a channel over which such traffic-related-event messages are broadcast.

### PRIORITY CLAIM

The instant application claims priority to Italian Patent Application No. VI2010A000165, filed Jun. 6, 2010, which application is incorporated herein by reference in its entirety.

### TECHNICAL FIELD

An embodiment relates to a routing method and the corresponding implementing system for routing a message in a vehicular ad-hoc network. More specifically, an embodiment relates to an improved routing method which reduces overcharging of the network by a simple technique.

### BACKGROUND

Recently, the world of people and goods transportation has witnessed a steep increase in the number of vehicles travelling along the roads. The need of solutions enhancing drivers' and passengers' safety, reducing road accidents, mitigating air pollution and optimizing traffic flows has therefore become more and more urgent. Accordingly, the development of an integrated transportation system (ITS), leveraging on wireless data communication, has been proposed. Such a system requires the creation of a network among the vehicles moving on the road. Such a network is named vehicular ad-hoc network (VANET).

VANETs are based on the assumption that, in a near future, vehicles will be equipped with wireless communication modules and will be able to communicate with each other so as to share a range of safety/traffic/infotainment information. This is expected to make driving more comfortable and safer, preventing and/or predicting and reacting to potentially dangerous situations, and entertaining the driver and the passengers.

Such kind of network will have to implement different routing schemes ranging from unicast to broadcast. Unicast messages may be used so as to exchange a private message between two vehicles, for instance, a voice communication between two drivers. On the other hand, broadcast messages may be used, for instance, to rapidly inform a large number of vehicles of potentially dangerous situations or of any other situation which should be known by a large number of drivers, such as traffic congestions.

It is generally accepted that, due to the peculiarities of the VANETs, a broadcast message should be propagated with a flooded strategy. That is, each node should relay the broadcast message until a certain time has elapsed or until the message has travelled a predetermined distance from its origin. However, both approaches are problematic in that they create a large amount of traffic on the network, thereby potentially preventing the other nodes from accessing the communication channel.

When the communication channel is congested, the number of messages that may be transmitted thereon is therefore reduced, causing a problem if more than one node has to transmit a message indicating, for instance, different emergency situations.

As an example, in FIG. 1 nodes 1013 and 1014 may be involved in an accident. Any, or both, of the two nodes may broadcast a message indicating such event in a region 1030. The region 1030 is limited due to the limited radio capabilities of the nodes, as well as obstacles such as buildings. In this case, the message may need to be relayed by other nodes so as to be received, for instance, at node 1011 in order to inform the driver of the danger ahead. By using a flooded strategy, the message would be sent from nodes 1013 and 1014 to node 1012, which would forward it back to nodes 1013 and 1014 as well as to node 1011. Accordingly, node 1011 may be informed. However, by flooding the network, also nodes 1022 and 1015 would receive the message and forward it, thereby occupying the communication channel in regions which are not affected by the accident. Putting a limit on the distance that the message may travel, or using a Time To Live (TTL), might improve the situation by preventing the message from being forwarded indefinitely. However, this will not prevent the transmission of the message to nodes 1022, 1015, 1021, 1016, 1023 and 1024.

Accordingly, it is desirable that an algorithm used to broadcast a message from a node to a plurality of interested nodes uses the network in the most efficient manner possible.

“VANET routing on city roads using real-time vehicular traffic information”, Josiane Nzouonta et al., which is incorporated by reference, relates to a routing protocol called Road-based using Vehicular Traffic information (RBVT). More specifically, the document deals with the problem of how to get a message from a source to a destination in a physical environment comprising different potential connecting roads. In order to do so, according to the document, it is necessary to construct an image of the network in each of the nodes. This is done by exchanging periodic “hello” messages among neighboring nodes so as to determine which roads are possible and which are not (cf. FIG. 2, FIG. 3 and first column of page 2 of the document). In order to explore the network so as to create a list of connected roads, a route discovery (RD) packet is flooded in the region around the source to discover possible network paths towards the destination. The document explicitly recognizes that such a flooding procedure is necessary and that, in order to limit the traffic overhead, if a node receives an RD packet with the same source address and sequence number as a previously received packet, it should discard it (cf. first column, page 3).

“GeOpps, Geographical Opportunistic routing for vehicular networks”, Ilias Leontiadis et al., which is incorporated by reference, also relates to the problem of sending a packet from a predetermined origin to a predetermined destination. The algorithm disclosed by this document makes usage of map information as well as GPS information which are constantly exchanged between the vehicles. More specifically, each driver is supposed to enter his destination every time the vehicle is used. Thanks to this operation, when two vehicles exchange a handshake packet, each of the two vehicles informs the other of its projected route and destination. If the vehicle carrying a packet to be delivered recognizes that the other vehicle will take a road that is closer to the destination of the packet, it will forward the packet to the other vehicle. On the other hand, if the vehicle carrying the packet recognizes that the other vehicle will deviate from the destination more than itself, it keeps the packet until a more suitable vehicle is found. Also this document requires the constant exchanging of “hello” packets or handshake patterns between neighboring cars, thereby drastically increasing the traffic overhead. Moreover, this algorithm is rendered very impractical by the fact that each driver is supposed to enter its destination every time the vehicle is used. In fact, the algorithm does not work without such information.

“A cross layered MAC and clustering scheme for efficient broadcast in VANETs”, Luciano Bonomi et al., which is incorporated by reference, relates to the problem of sending a broadcast alert message to a group of potential receivers in a zone that may be larger than the transmission range of the wireless device installed in the generating vehicle. The document recognizes the need to relay the packets through other vehicles present in the region so as to obtain an optimum coverage. In order to produce an efficient broadcasting, the document teaches to create a virtual backbone infrastructure in the network (cf. section 3.1 of the document). In order to do so, the document teaches to constantly exchange backbone creating messages between different vehicles in the VANET network (cf. second column, page 3 of the document). Accordingly, also this document requires a constant exchange of packets between nodes which has the effect of drastically increasing the traffic on the network, thereby preventing access to the network to potentially important messages.

“Directional broadcast forwarding of alarm messages in VANETs”, Luca Campelli et al., which is incorporated by reference, discloses a routing algorithm named REACT. In such algorithm, the choice of the next relaying node is based on the position of the current node, trajectory information inserted in packet, and information on neighboring nodes. By trajectory, it is meant the vector direction along which the packet needs to be sent. A car noticing an accident may spread this information to all the following cars travelling in the same direction on the same road, for instance, in the “north direction”. In order to implement such an algorithm, non-patent document 4 requests a constant exchange of beacon packets between the different nodes so that each node has knowledge of the position of the neighboring nodes. Based on such knowledge, and based on the vector direction indicated by the generating node, the next node is chosen such that the message does not deviate from the vector trajectory decided by the originating node more than a forwarding angle alpha. Also in this case, the constant exchange of beacon packets may overwhelm the network. Moreover, as may be seen in FIG. 2, nodes 2013 and 2014 generating a packet to be forwarded along direction 2019, would select vehicle 2015 as their next hop. Node 2015 may still select node 2012, assuming the position of node 2012 is within the tolerance angle. However, node 2012 would not be capable of further transmitting the packet to potentially impacted node 2011. Furthermore, the propagation along a specific and fixed vector direction might be problematic in the case where the message needs to relayed to a region of interested vehicles, such as vehicles located in a city district.

“Method, device and system for implementing directional broadcast in mobile data broadcasting”, US2007/0200728, which is incorporated by reference, relates to a method for implementing a directional broadcast in a mobile network. More specifically, the document teaches to send a message from a content server to a specific location identified by location information such as latitude and longitude. The routing to the specific location is achieved by having knowledge of the infrastructure and by forwarding the packet to a node closer to the destination, if the current node does not match the destination, or by flooding the network. Once the message reaches the destination, the message might be broadcast in a classic way. For instance, upon reaching a mall complex, the message may be broadcast to the entire mall, using a standard flooding approach. Therefore, this document also requires knowledge of the nodes positions, implying the exchange of handshake packets, or the usage of a flooding mechanism.

“GVGrid, a QoS routing protocol for vehicular ad hoc networks”, Weihua Sun et al., which is incorporated by reference, relates to a routing protocol for VANETs. Also in this case, in order to compute a route between the source and the destination, a route discovery process is carried out which requires each node to have a list of neighbors and their position information (cf. section 4.V of the document). Accordingly, the document also requires a constant exchange of packets among the nodes in order to maintain up-to-date knowledge of the topology of the network.

Accordingly, all the proposed techniques for routing a message in VANETs require the constant exchange of beacon or “hello” messages such that each node, or a subset of the nodes, has knowledge of the topology of the network. Such a constant exchange of beacon messages increases the traffic and represents a threat to the access to the communication medium in an environment containing a large number of nodes such as, for instance, a city.

### SUMMARY

Given these problems with the existing technology, it may be advantageous to provide a routing algorithm that allows the routing of a broadcasting packet in a VANET, with a minimum usage of the communication channel.

In an embodiment, this is achieved by allowing each node, which receives the message to be broadcast, to decide whether to broadcast the message or not, depending on the node position, the content of the message, and on map information. More specifically, when a node receives a message to be broadcast indicating, for instance, a car accident which has occurred at a certain crossroad, the node may evaluate the message information, for instance, the position of the accident and the type of accident. Furthermore, based on a road map analysis of its own position and the position of the origin of the message, the relaying node may decide whether it should broadcast the message or not.

For example, in an embodiment, a message may contain the geographic position of an event together with information indicating the direction along which the packet needs to be broadcast. For instance, the event may be traffic congestion and the direction may be pointing backward with respect to the direction of the car originating the message so as to alert other drivers in such a way that they may take alternative roads. In such a case, the car originating the message may include its own position and direction as well as the intended direction of propagation of the packet. Since the broadcast is realized with a radio technology, multiple cars surrounding the car originating the message may pick up the message. As this point, each of the cars may be capable of deciding, on its own and with no knowledge of the position of the other nodes, whether it should relay the packet or not. More specifically, since the direction information indicates a direction backward with respect to the originating car, if a node is placed in a position that is not backward with respect to the car originating the message, it might decide to discard the message. On the other hand, a node that is placed in a position which is backward with respect to the car originating the message might decide to relay the message.

In such a manner, the message may be broadcast along the directions specified by the originating car. This introduces the concept of “road direction”, that is, a direction along a road on a map, instead of “geographical direction”, that is, the direction along a certain geometrical vector on the map. The concept of “road direction” might also include other map descriptions such as parallel roads, perpendicular roads, or crossroads. Moreover, thanks to the analysis of the map, each of the nodes may be capable of intelligently interpreting the direction given by the originating car. For instance, in the case of a road which has a bend such as in FIG. 2, the meaning of “backward” might be interpreted by the nodes so as to mean “backward along the road”, instead of simply “backward in a straight line”. In this way, thanks to the content of the message, used in conjunction with the map information, each car may decide whether to relay the message or not. Accordingly, a constant exchange of packets between the cars so as to have knowledge of the other nodes and the position in the network is not required. This may drastically reduces the amount of traffic on the VANET. Moreover, with a simple algorithm, the message may be propagated only along the direction of interest instead of a flooded propagation. Accordingly, regions which are not affected by the message may still be able to access the communication medium.

Alternatively, or in addition, in an embodiment, a packet might only contain information regarding the position and the type of event to be communicated. In such a case, each node might decide whether to relay the packet or not by analyzing those two pieces of information together with map information and its own position. For instance, if the event is traffic congestion at a cross road, the neighboring nodes may “understand” that the message might need to be broadcasted along the four roads intersecting at the cross road, since all cars coming from the four direction may be impacted by this information. On the other hand, if the message is, for instance, traffic congestion on one side of a road due to road work, the neighboring nodes may understand that such a communication may only need to be forwarded in the direction of the cars that will eventually encounter the traffic congestion. Accordingly, the broadcast might have a unique direction of propagation as opposed to the previous example. In other words, by analyzing the type of event included in the message and the road map, each node may intelligently decide the region where the packet needs to be forwarded or not.

An embodiment is a packet routing method for broadcasting a packet in a Vehicular Ad-Hoc Network including a plurality of nodes, comprising the steps of: receiving, at a receiver node, the packet from a sender node; deciding, at the receiver node, whether to broadcast or to discard the packet on the basis of the position of the receiver node and a broadcasting region, the broadcasting region being determined on the basis of a content of the packet and map data; and if it is decided to broadcast the packet at the deciding step, broadcasting the packet.

According to an embodiment, the content of the packet includes at least map direction information and the broadcasting region is determined on the basis of the map direction information, the map direction information representing the direction along at least one map portion on which the packet has to be routed.

According to an embodiment, the content of the packet further includes at least creating node direction information and the map direction information is expressed with respect to the creating node direction information, the creating node direction information representing the direction along which a node creating the packet is travelling at the moment of or before the creation of the packet.

According to an embodiment, the content of the packet includes at least event information and the broadcasting region is determined on the basis of the event information, said event information describing a predetermined type of event and a location of the event.

According to an embodiment, the packet routing method may further comprise the step of judging whether the position of the receiver node is inside or outside the broadcasting region, and wherein it is decided to discard the packet if it is judged that the position of the receiver node is outside the broadcasting region.

According to a further embodiment, the packet routing method may further comprise the step of judging whether the area corresponding to the transmission range of the receiver node is inside or outside the broadcasting region, and wherein it is decided to discard the packet if it is judged that the area corresponding to the transmission range of the receiver node is outside the broadcasting region.

According to an embodiment, the packet routing method may further comprise the step of judging whether a map-constrained road from the position of the receiver node to the broadcasting region is longer than a predetermined value, and wherein it is decided to discard the packet if it is judged that the map-constrained road is longer than the predetermined value.

According to an embodiment, the content of the packet includes at least position information indicating a position of the sender node, and the packet routing method may further comprise the steps of waiting, at the receiver node, before broadcasting the packet, for an access time which is determined on the basis of the position information and the position of the receiver node; and deciding to discard the packet if a copy of the packet has been received during the access time.

According to an embodiment, the access time is determined so as to be longer when the receiver node is closer to the sender node.

According to an embodiment, the packet routing method may further comprise the steps of: waiting, at the receiver node, after broadcasting the packet, for a safety time; and deciding to broadcast the packet again if no copy of the packet has been received during the safety time.

According to an embodiment, the waiting and deciding steps are repeated a number of times which is determined on the basis of the content of the packet or on the basis of the position of the receiver node.

An embodiment is a computer program product comprising a computer readable medium having a computer readable program code embodied thereon, the program code being configured to carry out a method according to an embodiment such as one of the above- or below-mentioned embodiments.

An embodiment is a packet routing apparatus, for broadcasting a packet in a Vehicular Ad-Hoc Network including a plurality of nodes, comprising: an antenna for receiving and transmitting the packet; a modem, coupled to the antenna, for modulating and demodulating the packet; a CPU coupled to the modem;

a GPS receiver, coupled to the CPU, for evaluating the position of the apparatus; a memory, coupled to the GPS receiver and to the CPU, for storing CPU data, GPS data and map data, wherein the CPU is configured so as to determine a broadcasting region on the basis of a content of the packet and the map data, and so as to decide whether to broadcast or to discard the packet on the basis of the position of the apparatus and the broadcasting region.

According to an embodiment, the CPU is configured so as to carry out a method such as one of the above- or below-mentioned embodiments.

An embodiment is a packet routing system including a plurality of packet routing apparatuses according to an embodiment such as one of the above- or below-mentioned embodiments.

### BRIEF DESCRIPTION OF THE DRAWINGS

The accompanying drawings are incorporated into and form a part of a specification to illustrate several embodiments. These drawings together with the description serve to explain principles of one or more embodiments. The drawings are only for the purpose of illustrating examples of how one or more embodiments may be made and used, and are not to be construed in a limiting manner. Features and advantages will become apparent from the following and more particular description of the various embodiments, as illustrated in the accompanying drawings, in which like reference numbers refer to like elements and wherein:

FIG. 1 is a schematic drawing illustrating conventional flooded broadcasting of a message in a VANET;

FIG. 2 is a schematic drawing illustrating conventional directional broadcasting of a message in a VANET;

FIGS. 3, 4, 5 and 6 are schematic drawings illustrating examples of map-constrained broadcasting of a message in a VANET according to an embodiment;

FIG. 7 is a flow diagram illustrating an exemplary method for implementing a map-constrained broadcasting of a message in a VANET according to an embodiment;

FIG. 8 is a schematic drawing illustrating an exemplary implementation of a packet routing node according to an embodiment.

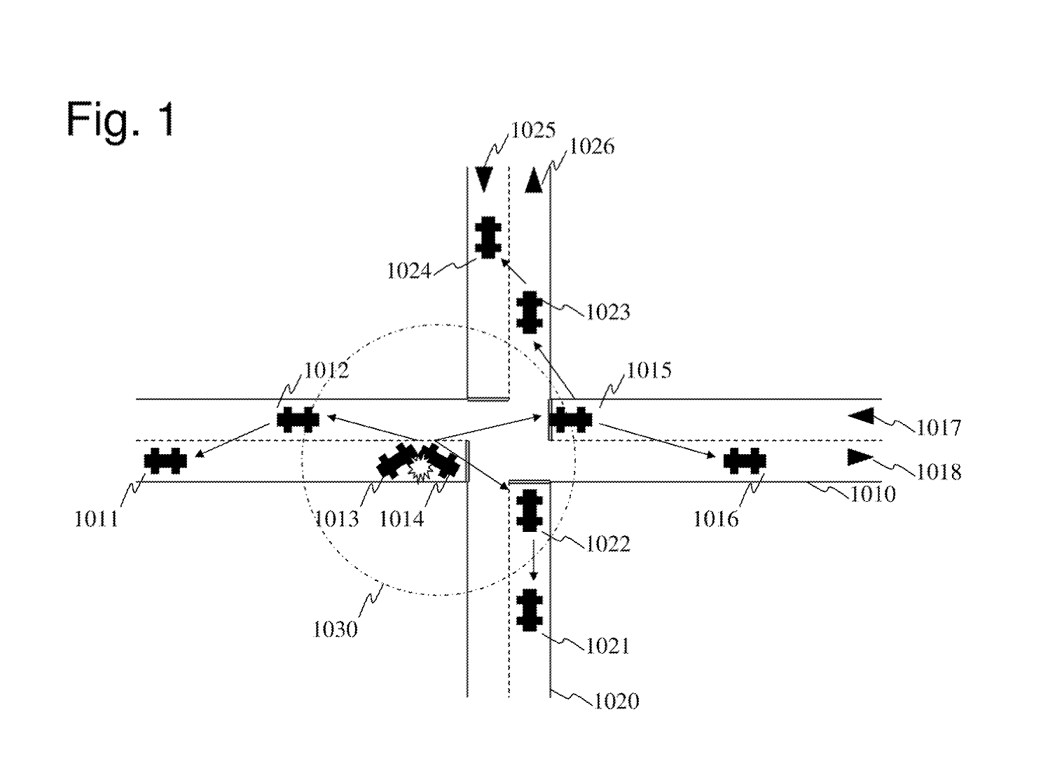

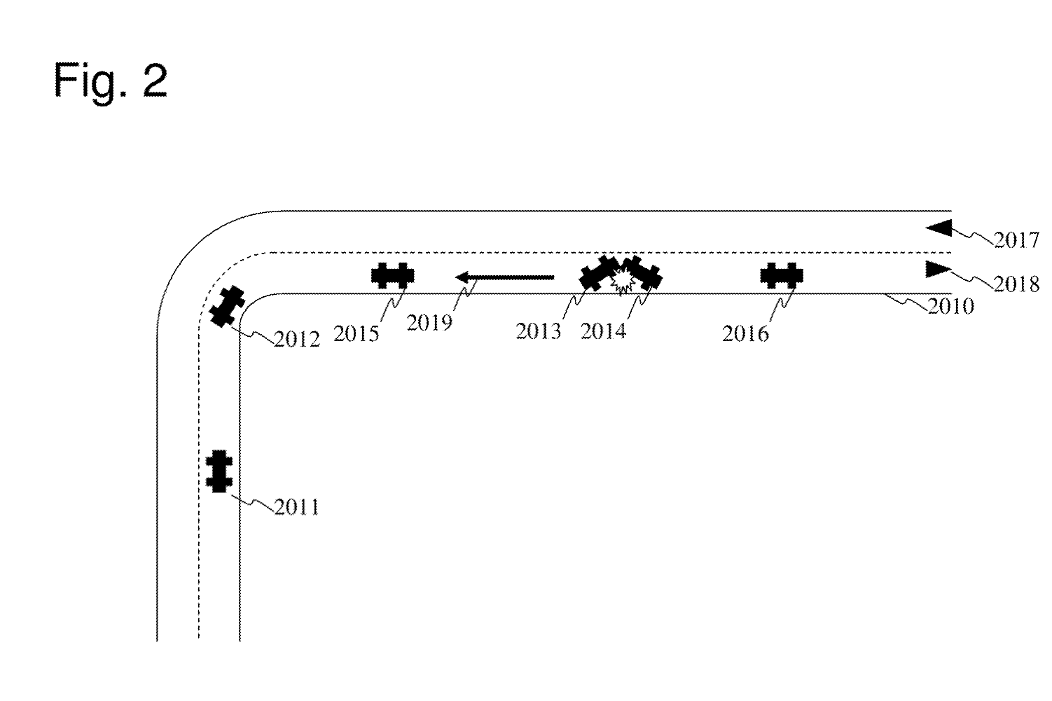

### DETAILED DESCRIPTION

In the following description, for explanatory purposes, specific details are set forth in order to provide a thorough understanding thereof. It may be evident, however, that one or more embodiments may be practiced without these specific details. Furthermore, well-known structures and devices are only described in a more general form in order to facilitate the description thereof.

The terms car, vehicle, and node are used to mean the same entity, that is, any vehicle of any kind (motorcycle, bicycle, car, truck, bus) moving in a VANET, equipped with the necessary hardware for accessing the network.

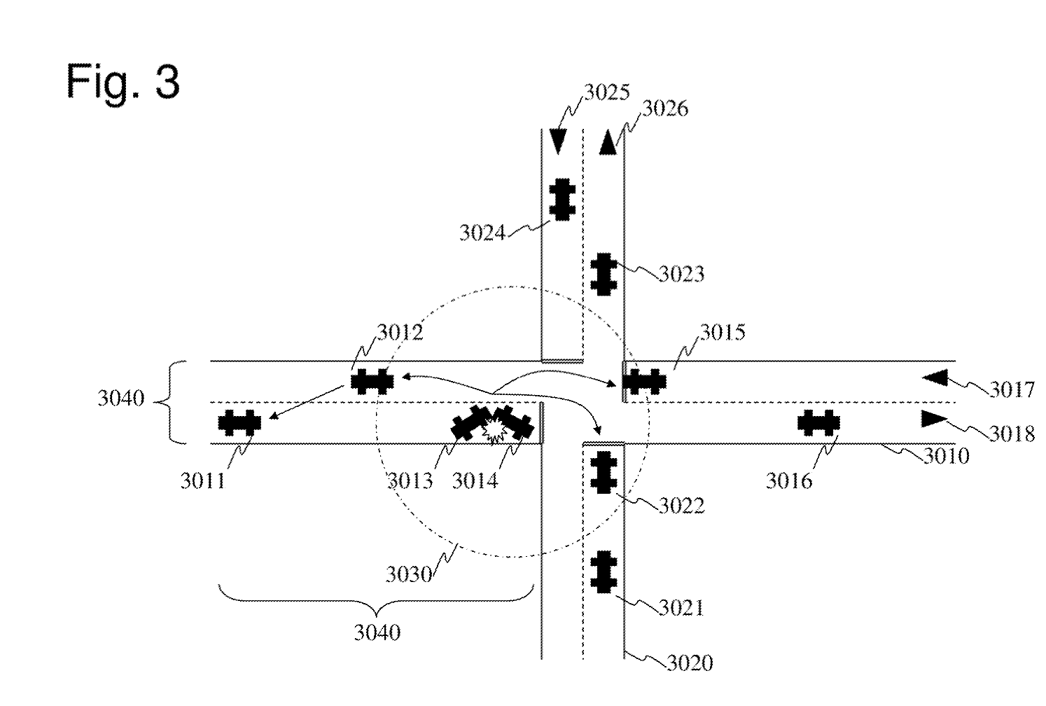

FIG. 3 represents a VANET network in which nodes 3011 to 3016 and 3021 to 3024 behave in accordance with the packet routing method of the present invention.

As may be seen in FIG. 3, a collision may happen between vehicles 3013 and 3014 on road 3010. At this point, either of vehicles 3013 or 3014, or both, may issue a packet in order to warn other vehicles, for instance the ones travelling on the same road of the accident. In the example illustrated in FIG. 3, such a packet may be of interest to vehicle 3011 travelling in direction 3018 of road portion 3040 of road 3010. On the other hand, it may be assumed that vehicles 3021, 3022, 3023 and 3024 travelling on road 3020, may not need to be informed of such an accident since they will most likely not drive in the lane blocked by the accident.

The radio broadcast of the packet by the vehicles involved in the accident is represented by the region 3030. As may be seen, the packet may be broadcast in a region 3030 centred on the originating node. In the example of FIG. 3, vehicles 3012, 3015 and 3022 are within the reach of broadcasting region 3030. Accordingly, each of those three vehicles might receive the packet including information concerning the accident. Contrary to the behavior of a conventional broadcasting system, not all of the vehicles 3012, 3015 and 3022 might decide to forward the packet. More specifically, with the aim of reducing broadcasting overhead, thereby allowing more access to the channel, each of the nodes receiving the packet might decide whether to forward the packet or not. In the example of FIG. 3, if the packet was originated, for instance, by vehicle 3014, the packet might include the position and/or the travelling direction of vehicle 3014 before the accident as well as a road direction along which the packet might need to be transmitted. An example of road direction may be “forward”, “backward”, or “forward-backward”. By road direction it is meant, for instance, the direction along the road with respect to the last recorded direction of the originating vehicle. Accordingly, in the example of FIG. 3, the packet might contain “backward” as a direction of propagation. In such a case, it would be the intention of vehicle 3014 to transmit the packet along the part 3040 of road 3010. Accordingly, when node 3012 receives the packet, it may analyze its own position and decide that the packet needs to be forwarded, since vehicle 3012 is placed in a direction which is backward with respect to the last direction of vehicle 3014, thereby respecting the condition prescribed in the packet. By forwarding the packet through vehicle 3012, vehicle 3011 may also be informed of the accident. On the other hand, vehicles 3015 and 3022 might decide not to forward the packet after analyzing their own position on the map with respect to the direction information inserted in the packet.

In the present example, it is assumed that the packet is created by vehicle 3014. Alternatively, or in addition, the packet may also be created by other vehicles in proximity of the vehicles 3013 and 3014. Alternatively, or in addition, the packet may be created by a fixed infrastructure such as sensors or cameras.

The broadcasting region 3030 is assumed to have a circular shape in the present example. However, an embodiment is not limited to this and broadcasting regions having a directional shape may be employed. For instance, by using a directional antenna, the broadcasting region may be directed toward the direction in which the packet needs to be transmitted.

Moreover, not all the nodes forwarding the message may be interested in showing the message content to the drivers. For instance, node 3012 may decide to forward the packet, being in the direction specified by the packet but may also decide not to show the packet to the driver by evaluating that the direction of vehicle 3012 will not lead the driver to the zone of the accident.

Furthermore, in the present example, the packet forwarding direction is exemplified as being “forward”, “backward”, or “forward-backward”. However, other direction definitions may be supported such as “reserved”. Alternatively, or in addition, a number of cross roads to be crossed by the packet may be specified. Moreover, the direction may be specified in terms of parallel roads or roads perpendicular to the road in which the vehicle generating the message is placed. Furthermore, the distance along the road from the packet to the end of the region in which the packet is to be transmitted may be specified. Additionally, a more complicated direction description may be supported such as “backward plus perpendicular roads for the next two crossroads”, which may propagate the message in the backward direction as well as the two perpendicular roads crossing the road in which the message is generated in the first two crossroads in the direction of the packet propagation. These and other direction information may be evaluated by the relaying nodes based on map data representing at least the region in which the nodes are placed as well as the origin point of the packet and the intended destination region and describing map features such as roads, squares, crossroads, bifurcation (e.g., a divided roadway), types of roads, distances along the roads, elevation of the roads, tunnels, as well as geographical features such as mountains, lakes, valleys, hills, buildings, bridges and so on. In other words, the node may evaluate, on the basis of the content of the packet and the map data, a region in which the packet needs to be relayed. Such region may be expressed in terms of map-based locations (i.e., around a hill, along a road, throughout a square, inside a tunnel, through a certain number of crossroads) instead of simply position-based locations (i.e., latitude/longitude or any other two dimensional coordinate system).

By using such an algorithm, access to the communication channel may be limited only to the regions in which the packet needs to be transmitted. Accordingly, bandwidth may be reserved in geographical areas which do not need to be informed about the message. Moreover, by evaluating whether to forward the packet or not on the basis of the message content and on map data, each node might make this decision without any knowledge of the position of the other nodes. Accordingly, it might be possible to implement an embodiment without the use of periodic handshake or “hello” packets, thereby further limiting communication overhead.

In the present example, it is assumed that the node generating the message may specify the direction along which the message should be forwarded. However, embodiments are not limited to this and it is possible to implement an embodiment without specifying such a direction.

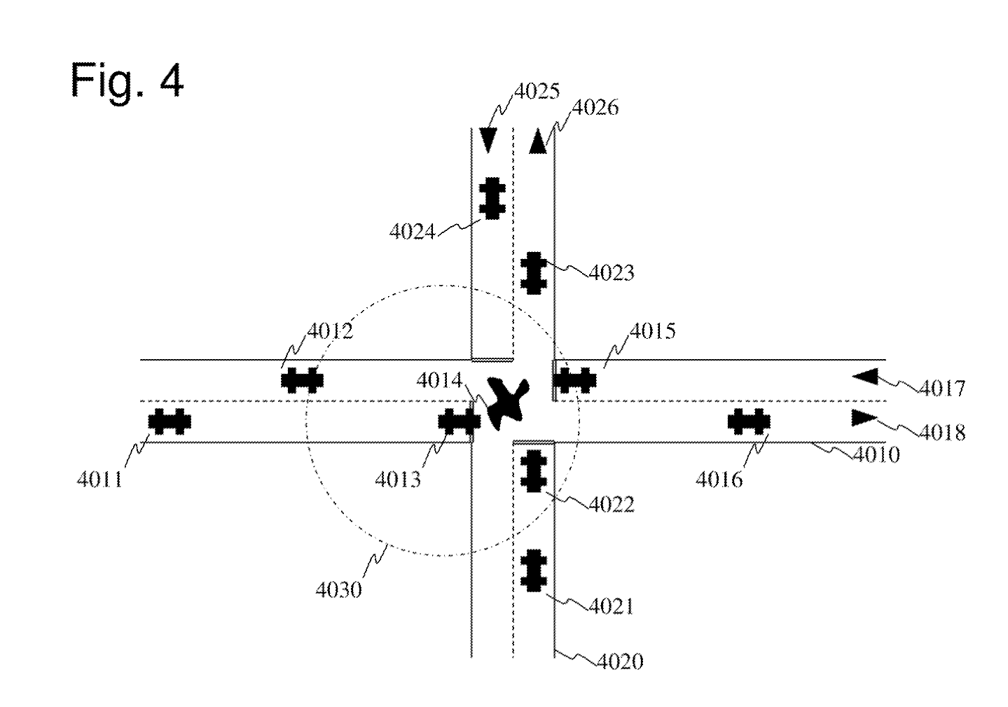

In the example of FIG. 4, vehicle 4013 might detect an oil leak 4014 at the crossing of roads 4010 and 4020. Accordingly, vehicle 4013 might generate a broadcast message including information concerning the position and the nature of the oil leak 4014. In the example of FIG. 4, such a broadcasting message may be received by vehicles 4012, 4015 and 4022. Each of the vehicles 4012, 4015 and 4022 might decide to forward the packet after evaluating that cars travelling in both directions of roads 4010 and 4020 might be impacted by the oil leak. For instance, vehicle 4012 might decide to forward the packet after evaluating that road 4010 has two directions 4017 and 4018 and that a vehicle in the proximities of vehicle 4012 might travel in direction 4018 leading to the oil leak 4014. In the example of FIG. 4 such a vehicle may be vehicle 4011. Similarly, vehicle 4022 might decide to forward the packet after evaluating that vehicles travelling in direction 4026 of road 4020 might be impacted by the oil leak 4014. For instance, the message forwarded in such a manner may reach vehicle 4021 which might not have been reached by the original message broadcast by vehicle 4013 in region 4030.

In this example, the content of the message might include the position of the event and the type of event, in this case, an oil leak 4014. Based on this information, each vehicle receiving the packet might decide whether or not to forward the packet independently, that is, without a specific forwarding direction from the generating node.

As a further example, the event to be broadcast may be, as in FIG. 3, a road accident in road 3010, the vehicles receiving the packet might decide whether to forward or not based on the analysis of map data and the packet content. That is, for instance, vehicle 3022, might decide not to forward the packet as it might evaluate that vehicles travelling along 3020 might not encounter the accident described in the packet.

In other words, based on the type and location of the event, and based on map data such as any of road position, road intersection, road directions, traffic signs, road elevation and so on, any node might evaluate a region in which the packet should be forwarded. Moreover, by knowing its own position, it might decide whether it should forward the message or not.

By using such an algorithm, the originating node may not need to include propagation direction information describing the direction along which the packet needs to be forwarded. The decision of the directions along which the packet needs to be forwarded as well as the total distance from the event to which the packet needs to be forwarded, may be left to each of the nodes, to be taken based on the packet content, the position of the node, the position of the event, and road information.

In the previous examples, the node originating the message has been described as being within the region in which drivers should be informed of the event described by the originating vehicle. However, embodiments are not limited to this and it may be implemented in such a way that each vehicle may be capable of deciding whether to forward the packet or not and whether to show the packet to the driver or not.

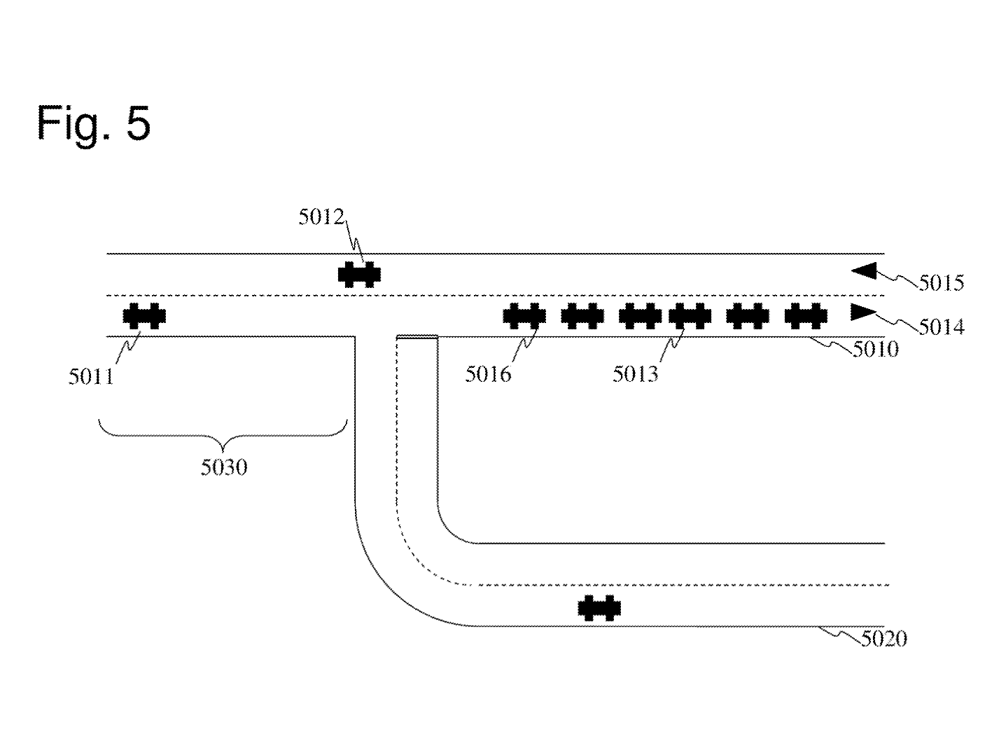

For instance, in FIG. 5, vehicle 5013 might decide to issue a packet indicating congestion in direction 5014 of road 5010. The aim of such a packet may be, for instance, to inform vehicles travelling in part 5030 of road 5010 in direction 5014 to take a turn in road 5020 in order to avoid the traffic congestion. Accordingly, although vehicles in the propagation direction such as 5016, 5012 and 5011 might decide to forward the packet, some of the forwarding vehicles might decide not to show the packet to the driver. For instance, vehicles 5016 and 5012 might decide to forward the packet so as to reach region 5030 of road 5010 and might also decide not to show the packet to the driver after evaluating that vehicle 5016 is in a position that does not allow the driver to turn on road 5020 while vehicle 5012, travelling along direction 5015, would not be impacted by the traffic congestion. On the other hand, vehicle 5011 might decide to forward the packet to other vehicles as well as to show the packet to the driver so as to help him avoid the traffic congestion. In such an example, both the independent decisions of forwarding the packet and showing the packet to the driver may be based on the content of the packet as well as map information.

In the previous examples, each of the nodes receiving the packet might decide whether to forward it or not depending on any of: its location, map data, and the content of the message. More specifically, each of the nodes receiving the message might decide not to forward the message if they are not placed in a region where the message does not need to be forwarded. However, embodiments are not limited to this.

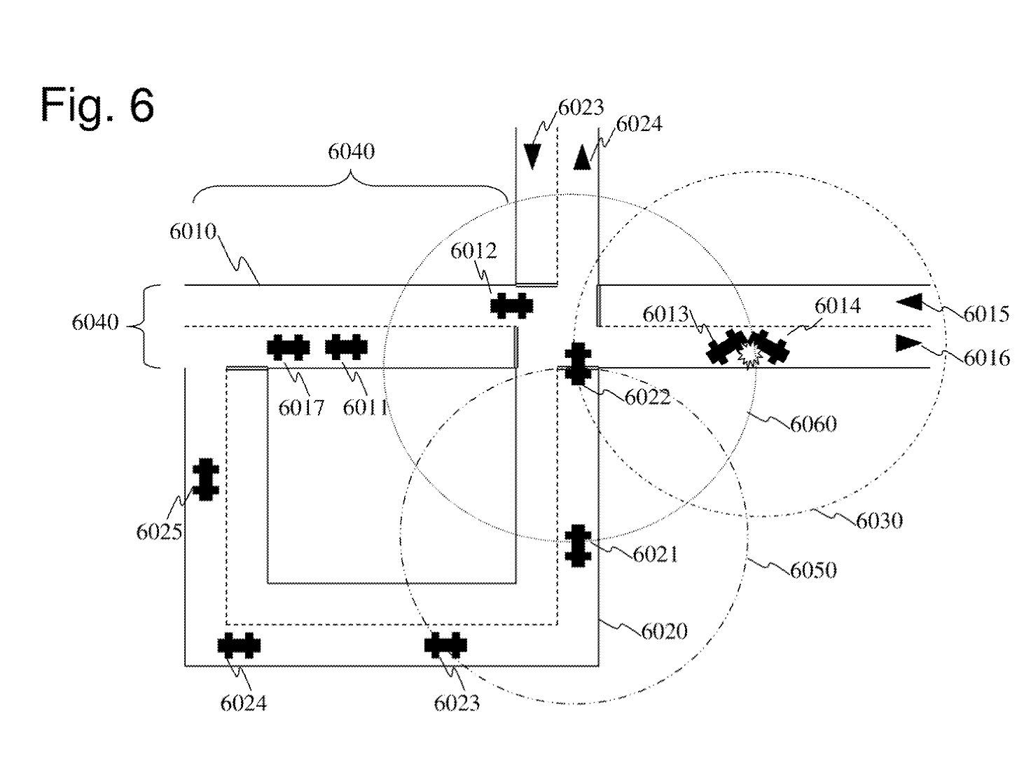

For instance, as may be seen in FIG. 6, node 6022 may receive a packet originated by either vehicle 6013 or 6014 since node 6022 is placed within area 6030 covered by the radio transmitting power of the originating vehicle. When analyzing its own position, node 6022 would find itself to be placed on road 6020 in direction 6024. Accordingly, node 6022 might decide not to forward the message since the message might only be of interest to vehicles travelling in direction 6016 of road 6010, such as vehicle 6011.

Alternatively, or in addition, node 6022 might analyze map data with respect to its own power broadcasting capabilities and realize that area 6060 in which vehicle 6022 might be able to broadcast includes part of region 6040 of road 6010 in which the message may need to be broadcast. Accordingly, even though vehicle 6022 might not be affected by the message and might travel along a road which might not be the road along which the message needs to be propagated, vehicle 6022 might decide to broadcast the message since it is possible that vehicles in the direction in which the message needs to be propagated might be reached by the broadcast of vehicle 6022. In the example of FIG. 6, vehicle 6012 might be in fact reached by the radio transmitting power of vehicle 6022 while it might not be reached by the radio transmitting powers of either of vehicles 6013 or 6014. Accordingly, by using such a decision algorithm, even a node which may not be placed, or may not be travelling along the direction in which the message needs to be propagated, might decide to forward the message if it is judged that the area which may be covered by radio broadcasting capability might include nodes which may need to be reached by the message.

Alternatively, or in addition, vehicle 6021 receiving the message from vehicle 6022 might decide not to transmit the message after evaluating that its own radio capabilities limit the reachable area 6050 to a region in which nodes might not need to be reached by the message. For instance, if node 6021 determined that road 6020 in direction 6024 forbids vehicles travelling along direction 6024 to turn on road 6010 along direction 6016, then vehicle 6021 might decide that none of the vehicles within its own power range may be interested in receiving or forwarding the message. Accordingly, vehicle 6021 might decide not to forward the message. In other words, vehicle 6021 might determine that, in the area 6050 that it may reach, vehicles will either move in direction 6023 and will therefore not be impacted by the event; or that vehicles will move in direction 6024 but will not be able to turn on road 6010 in direction 6016 and will therefore not be impacted by the event.

Alternatively, or in addition, by analyzing map data, a node might decide to forward the packet if it is judged that there exists a road, shorter than a predetermined length, which may lead to the intended distribution region of the packet, even if this road is not the one potentially specified by the originating node. For instance, in FIG. 6, vehicle 6021 might recognize that a road exists, connecting its position with the destination region 6040 of road 6010. Vehicle 6021 might compute the length of such connecting road and decide to forward the packet if the road is shorter than a predetermined length. In such a way, the geographical spread of the packet may still be limited and higher chances of routing the packet to the intended destination region may be achieved.

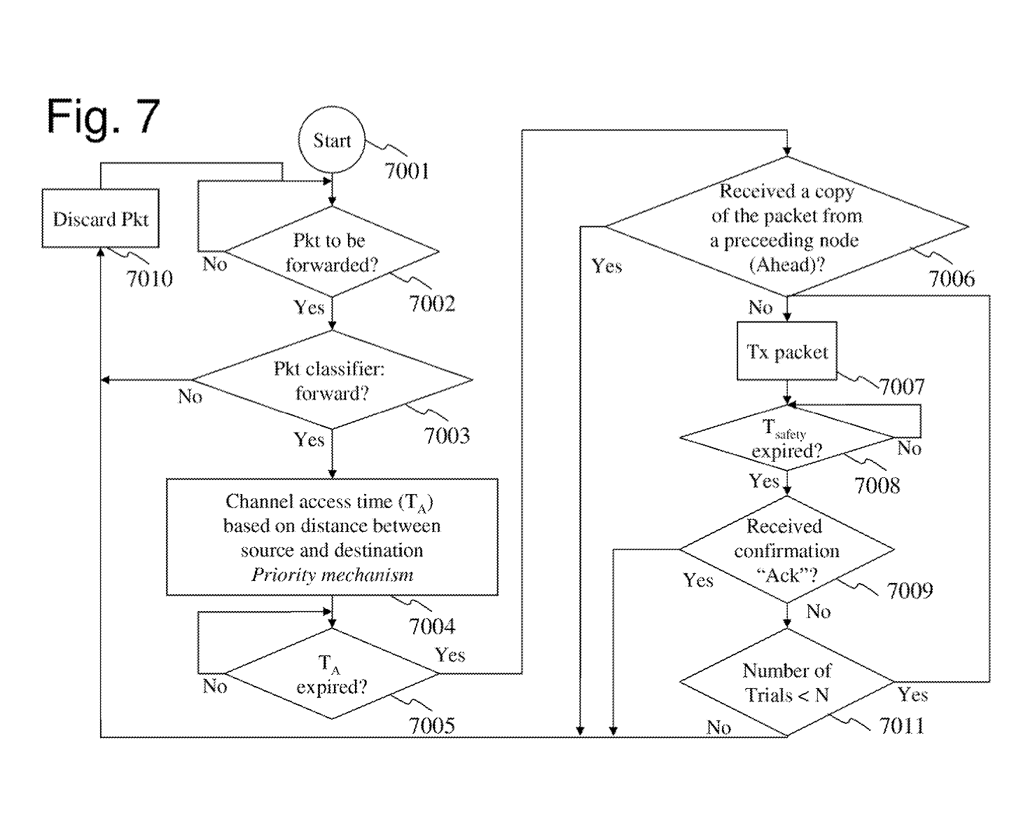

FIG. 7 illustrates an exemplary flow diagram representing a possible implementation of an algorithm according to an embodiment. Any given node, after starting in step 7001, may wait until it receives a packet to be forwarded at step 7002. When such a packet is received, assuming that the system is implemented so as to include in the packet the direction along which the packet needs to be forwarded (for instance “forward”) the node may judge, based on its own position and map data, whether it is placed in the direction specified by the packet with respect to the position of the originating node, which may be also specified in the packet. In the present example, if the node determines that it is not placed in the direction specified in the packet, it may discard the packet at step 7010. On the other hand, if the node determines that it is placed within the direction along which the packet needs to be forwarded, it may compute an access time Tₐ based on the distance between the source of the packet and its own position at step 7004. In other words, the packet might include the information describing the position of the node which is currently broadcasting the packet. Based on the distance between the node which is currently receiving the packet and the node which is currently broadcasting the packet, the node which is currently receiving the packet may compute the access time. The access time might be computed so as to be longer for receiving nodes which are closer to the broadcasting node. For instance, when referring to FIG. 6, both nodes 6012 and 6021 may receive the message broadcast by node 6022 in region 6060. Upon receiving the message, each of nodes 6012 and 6021 may compute its own distance from the originating node, that is, node 6022. In the example of FIG. 6, node 6012 may find itself closer to node 6022 than node 6021. Accordingly, node 6012 might compute an access time Tₐ which is longer than the access time computed by the node 6021. In this manner, nodes which are further away from the originating node, might get a quicker access to the channel than nodes which are closer. Accordingly, the message might be broadcast at a quicker speed. Furthermore, a broadcast-storm, that is, un-necessary retransmissions, is avoided.

Alternatively, or in addition, the access time might be determined as a function of the position of the node with respect to the region or the direction in which the packet needs to be forwarded. For instance, still referring to the example of FIG. 6, node 6012 might determine that its own position is closer to the region 6040 in which the message needs to be propagated. At the same time, node 6021 may determine that its own position is further away from region 6040. Accordingly, the function computing the access time may be specified so as to provide a shorter waiting time to access the channel to those nodes which are better placed with respect to the direction along which the message needs to be propagated.

After waiting for an access time Tₐ at step 7005, the node might check whether it has received a copy of the packet from a node better placed in the direction of propagation of the packet at step 7006. For instance, referring to the example of FIG. 6, assuming that both nodes 6011 and 6017 receive the packet from node 6012, and assuming that the direction along which the message is specified to be propagated is direction 6015 along road 6010, nodes 6011 and 6017 might compute different access times as a function of their position with respect to either their distance from the originating node 6012 or their position with respect to the propagation direction as explained above.

In the following, it is assumed that the access time for node 6011 may be computed so as to be longer than the access time for node 6017. In such a case, node 6017 may decide to forward the packet sooner than node 6011. If so, node 6011 may receive a copy of the packet from node 6017 which is better placed in the direction of propagation of the packet, when the access time of node 6011 has expired. Accordingly, node 6011 at step 7006 may decide to discard the packet at step 7010. This mechanism solves one of the main issues of georouting: the protocol may introduce an acknowledge mechanism without using new data or specific handshake. More importantly, it may avoid unnecessary retransmission and consequently broadcast-storm. If no copy of the packet is received at step 7006, the node may decide to forward the packet at step 7007. After waiting a safety time T_{safety} at step 7008, the node may check whether a copy of the packet is received at step 7009. In such a case, the node may assume that another node has received the packet and it is now forwarding it in the direction of propagation, thereby proceeding to discarding the packet at step 7010. On the other hand, if no copy of the packet is received, the node may proceed to step 7011 and check whether the packet has already been retransmitted a predefined number of times (N). Such a retransmission may be specified so as to be executed for a maximum predefined number of times N, for instance, 1, 2 or 3. In this example, the node may decide whether to retransmit or not at step 7009 on the basis of a reception of a copy of the packet from a node better placed in the direction of propagation of the packet. Alternatively, a specific acknowledge packet may be introduced to be used by the node forwarding the packet to inform the node from which the packet was received that the packet has been forwarded.

Although in the example of FIG. 7 the direction along which the packet needs to be forwarded may be checked in step 7003, other information may be checked such as the type of event as described above. Moreover, the access time Tₐ may be computed by taking into account the content of the message. For instance, a more urgent message may result in a lower access time. Alternatively, or in addition, the steps of retransmitting the packet for a predefined number of times if no acknowledge packet is received, namely steps 7008 and 7009, may be skipped so as to save computational power and to reduce access to the communication channel. Furthermore, the decision on the maximum number of times N for which a packet might need to be retransmitted to be used in step 7011 may be computed based on the content of the message. For instance, a message identifying a more urgent or a more dangerous event may be retransmitted a higher number of times than a message identifying traffic congestion. The correspondence between the type and/or urgency of the message and the value of N may be stored in the node, thereby avoiding the transmission of this information in the packet. Alternatively, or in addition, N may be decided on the basis of the network density; for instance, a city network (high density) may cause a small N, while a network outside the city (low density) may cause a bigger N. The type of network and the corresponding network density may also be evaluated on the basis of the map data and the position of the node so, also in this case, the number N does not need to be inserted in the packet. Alternatively, or in addition, N may be decided on the basis of the distance from the node which created the packet, in the case where the position of the node which created the packet is included in the packet. In this case, N may be lower for a greater distance, since the greater distance may imply a lower urgency to transmit the message to other nodes. Alternatively, or in addition, the value of N may be explicitly included in the packet.

Although in step 7006 reference is made to a node better placed in the direction of propagation of the message, the decision on whether to discard the packet or to transmit may be made based on other factors. For instance, based on the evaluated map data, the current node may decide that it has better probability to reach other nodes placed in the intended direction or region of propagation than the node from which the message is received, even if the node from which the message is received is placed further in the direction of propagation of the message. For instance, in a mountain scenario, assuming that the current node is placed on the top of a hill, and it is waiting the access time at the step 7005, when it receives the copy of the packet from a vehicle in the direction of propagation of the message which is placed in a valley at the bottom of the hill, the current node may decide to forward the packet nonetheless as, being placed on the top of the hill it may have a better chance of reaching other nodes in the direction of propagation of the message than the node placed down in the valley. The same may be valid in the case of a road with a U-turn. A node may decide to transmit anyhow, even if it received a confirmation copy from a vehicle placed further in the propagation direction, in the U-turn bend, if it is judged that, due to the configuration of the road, it has a better chance to reach the cars on the other side of the U-turn.

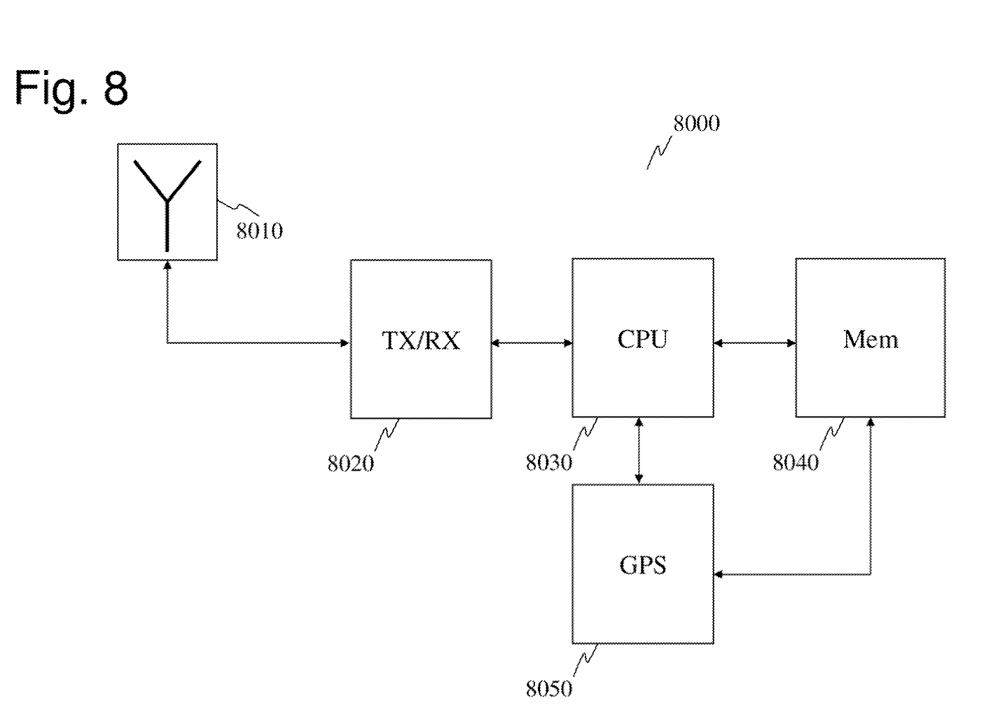

FIG. 8 illustrates an exemplary realization of a packet routing system 8000 which may be included in a vehicle in a VANET. As may be seen in FIG. 8 the packet routing system 8000 may include an antenna 8010 for receiving and transmitting the packet; a modem 8020, coupled to the antenna, for modulating and demodulating the packet; a CPU 8030 coupled to the modem; a GPS receiver 8050, coupled to the CPU, for evaluating the position of the vehicle; a memory 8040, coupled to the GPS receiver and to the CPU, for storing CPU data, GPS data and map data. In such system, the CPU may be configured so as to determine a broadcasting region on the basis of the content of the packet and map data as described above, and so as to decide whether to broadcast or discard the packet on the basis of the position of the node and the determined broadcasting region as described above.

Although FIG. 8 illustrates a GPS receiver for receiving position information, the position of the vehicle may be evaluated by other means such as a cellular communication apparatus, a radio triangulation system, retrieved by an infrastructure on the road, or input by the driver.

Although the type of event to be broadcast has been described as an oil leak, an accident, or a traffic congestion, embodiments are not limited to these and any kind of event may be supported, such as a fire, a weather alert, a police car needing to pass through the traffic, a traffic light switching, or any other kind of event related to the circulation of vehicles or, more generally, any data packet such as text, sound, or video.

According to an embodiment by combining the analysis of the content of the packet to be forwarded and the analysis of map data, each node may independently decide whether to forward the packet or not without requiring any special knowledge of the position of the other nodes in the network. Accordingly, a constant access to the communication channel due to beacon messages or handshake messages may be avoided. Moreover, the propagation of the message may be restricted to the region or the direction along which the message needs to be propagated. Accordingly, a free channel may be maintained in those regions in which the packet does not need to be forwarded, thereby allowing other nodes to access the communication medium in order to transmit other packets.

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. An apparatus, comprising:
a receiver operable to receive a message; and
a processor operable to determine whether to broadcast the message.

2. The apparatus of claim 1 wherein the receiver is operable to receive the message from a node.

3. The apparatus of claim 1 wherein the receiver is operable to receive the message from a vehicle.

4. The apparatus of claim 1 wherein the processor is operable to determine whether to broadcast the message based on a location of the receiver.

5. The apparatus of claim 1 wherein the processor is operable to determine whether to broadcast the message based on the message.

6. The apparatus of claim 1 wherein the processor is operable to determine whether to broadcast the message based on a map of an area in which the receiver is located.

7. The apparatus of claim 1 wherein the processor is operable to determine whether to broadcast the message based on a map of an area in which a source of the message is located.

8. The apparatus of claim 1 wherein the processor is operable to determine whether to broadcast the message based on a heading of the receiver relative to a location identified by the message.

9. The apparatus of claim 1 wherein the processor is operable to determine whether to broadcast the message based on a distance between the receiver and a location identified by the message.

10. The apparatus of claim 1 wherein the processor is operable to determine whether to broadcast the message based on a location of the receiver relative to a location identified by the message.

11. The apparatus of claim 1, further comprising a transmitter operable to broadcast the message in response to the processor determining to broadcast the message.

12. The apparatus of claim 1 wherein the processor is operable to wait an access time before determining whether to broadcast the message.

13. The apparatus of claim 1 wherein the processor is operable to wait an access time before determining whether to broadcast the message, the access time related to a distance between the receiver and a source of the message.

14. The apparatus of claim 1 wherein the processor is operable to wait an access time before determining whether to broadcast the message, the access time inversely proportional to a distance between the receiver and a source of the message.

15. The apparatus of claim 1 wherein the processor is operable to wait an access time before determining whether to broadcast the message, the access time related to a distance between the receiver and a location identified by the message.

16. The apparatus of claim 1 wherein the processor is operable to wait an access time before determining whether to broadcast the message, the access time related to a location of the receiver.

17. The apparatus of claim 1 wherein the processor is operable to wait an access time before determining whether to broadcast the message, the access time related to a location of a source of the message.

18. The apparatus of claim 1 wherein the processor is operable to wait an access time before determining whether to broadcast the message, the access time related to a location identified by the message.

19. The apparatus of claim 1 wherein if the processor determines to broadcast the message, the processor is operable:
to broadcast the message; and
to rebroadcast the message if the receiver does not receive the broadcast message within a safety time.

20. The apparatus of claim 1 wherein if the processor determines to broadcast the message, the processor is operable:
to broadcast the message;
to rebroadcast the message if the receiver does not receive the broadcast message within a safety time; and
to repeat the step of rebroadcasting up to a limit number of times.

21. The apparatus of claim 1, further comprising an antenna coupled to the receiver.

22. A system, comprising:
a receiver operable to receive a message; and
a processor coupled to the receiver and operable to determine whether to broadcast the message.

23. The system of claim 22, further comprising a global positioning system coupled to the processor.

24. The system of claim 22, further comprising a memory coupled to the processor.

25. The system of claim 22, further comprising a transmitter coupled to the processor.

26. The system of claim 22, further comprising an antenna coupled to the receiver.

27. A vehicle, comprising:
a receiver operable to receive a message; and
a processor operable to determine whether to broadcast the message.

28. An method, comprising:
receiving a message; and
determining whether to broadcast the message.

29. The method of claim 28 wherein receiving the message comprises receiving the message from a vehicle.

30. The method of claim 28 wherein receiving the message comprises receiving the message from a vehicle that is related to an event that is identified by the message.

31. The method of claim 28 wherein receiving the message comprises receiving the message from a vehicle that is unrelated to an event that is identified by the message.

32. The method of claim 28 wherein receiving the message comprises receiving the message from a source that is related to vehicle travel region.

33. The method of claim 28 wherein determining whether to broadcast the message comprises determining whether to broadcast the message based on a content of the message.

34. The method of claim 28 wherein determining whether to broadcast the message comprises determining whether to broadcast the message based on a map.

35. The method of claim 28 wherein determining whether to broadcast the message comprises determining whether to broadcast the message based on a heading of an object in which the receiver is disposed relative to a location identified by the message.

36. The method of claim 28 wherein determining whether to broadcast the message comprises determining whether to broadcast the message based on a distance between an object in which the receiver is disposed and a location identified by the message.

37. The method of claim 28 wherein determining whether to broadcast the message comprises determining whether to broadcast the message based on a location of an object in which the receiver is disposed relative to a location identified by the message.

38. The method of claim 28, further comprising broadcasting the message in response to the processor determining to broadcast the message.

39. The method of claim 28, further comprising:
determining to broadcast the message; and
waiting an access time before broadcasting the message.

40. The method of claim 28, further comprising:
determining to broadcast the message; and
before broadcasting the message, waiting an access time that is related to a location of an object in which the receiver is disposed.

41. The method of claim 28, further comprising:
determining to broadcast the message; and
before broadcasting the message, waiting an access time that is related to a location of a source of the message.

42. The method of claim 28, further comprising:
determining to broadcast the message; and
before broadcasting the message, waiting an access time that is related to a location identified by the message.

43. The method of claim 28, further comprising:
broadcasting the message; and
rebroadcasting the message if the receiver does not receive the broadcast message within a safety time.

44. The method of claim 28, further comprising:
broadcasting the message; and
rebroadcasting the message up to a number of times if the receiver does not receive the broadcast message within a safety time.

45. A tangible computer-readable medium storing instructions that when executed, cause a processor to determine whether to broadcast a message received by the processor.
